(19) United States
(12) Patent Application Publication
(10) Pub. No.: US 2019/0318249 A1
(43) Pub. Date: Oct. 17, 2019

(54) INTERPRETABLE GENERAL REASONING SYSTEM USING KEY VALUE MEMORY NETWORKS

(71) Applicant: International Business Machines Corporation, Armonk, NY (US)

(72) Inventors: Kun Xu, Elmsford, NY (US); Lingfei Wu, Elmsford, NY (US); Vadim Sheinin, Yorktown Heights, NY (US); Wei Zhang, Elmsford, NY (US)

(21) Appl. No.: 15/952,698

(22) Filed: Apr. 13, 2018

(51) Int. Cl. G06N 5/02; G06N 7/00; G06F 17/30

(52) U.S. Cl. CPC G06N 5/02; G06F 17/30474; G06N 7/005

(57) ABSTRACT

Technologies for interpretable general reasoning system using key value memory networks are described. Aspects include processing a complex question having at least two subject and relation pairs into keys in key memory locations, and importing entities of a knowledge base as values into value memory locations based on the keys and importing a STOP key. Other aspects include generating a query representation, a key representation of the keys in the key memory locations, and a value representation of the values in the value memory locations; and updating the query representation into an updated query representation over one or more iterations by combining the query representation with the value representation and the key representations until the STOP key is detected.

### TECHNICAL FIELD

The subject disclosure relates to convolutional neural networks, and more specifically, to using sparse and complementary convolutional kernels to reduce computing resource consumption with respect to convolutional neural network processing.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus and/or computer program products facilitating providing efficient convolution neural networks are described.

According to an embodiment, a system can comprise a memory that stores computer executable components and a processor that executes computer executable components stored in the memory. The computer executable components can comprise a question embedding and key hashing component that processes a complex question having at least two subject and relation pairs into keys in key memory locations, imports entities of a knowledge base as values into value memory locations based on the keys, and imports a stop key into an unused value memory location. The system can further comprise a key addressing and value reading component that generates a query representation, a key representation of the keys in the key memory locations, and a value representation of the values in the value memory locations, and a query updating component that updates the query representation into an updated query representation over one or more iterations by combining the query representation with the value representation and the key representations.

According to another embodiment, a computer-implemented method is provided. The computer-implemented method can comprise processing a complex question having at least two subject and relation pairs into keys in key memory locations, and importing entities of a knowledge base as values into value memory locations based on the keys. The computer implemented method can further comprise generating a query representation, a key representation of the keys in the key memory locations, and a value representation of the values in the value memory locations, and updating the query representation into an updated query representation over one or more iterations by combining the query representation with the value representation and the key representations.

According to yet another embodiment, a computer program product facilitating reasoning using a key value memory network can be provided, the computer program product comprising a computer readable storage medium having program instructions embodied therewith, the program instructions executable by a processor to cause the processor to, based on a question, generate a query representation, load keys into key memory locations, and import entities of a knowledge base as values into value memory locations based on the keys. The program instructions can be further executable to generate a key representation of the keys in the key memory locations, and a value representation of the values in the value memory locations. The program instructions can be further executable to update the current query representation into an updated query representation by combining the query representation with the value representation and the key representations to provide the updated query representation as the current query representation over one or more iterations until a stop key is detected, and return an answer to the question.

### DESCRIPTION OF THE DRAWINGS

FIG. 1 is a block diagram of an example, non-limiting system that illustrates various aspects of the technology in accordance with one or more embodiments described herein.

FIG. 2 illustrates a block diagram representing example components corresponding to the various technical aspects of FIG. 1 comprising various example components of a key-value memory network model in a first iteration that is directed to answering a question in accordance with one or more embodiments described herein.

FIG. 3 illustrates a block diagram representing example components corresponding to the various technical aspects of FIG. 1 comprising various example components of a key-value memory network model in a second iteration that is directed to answering a question in accordance with one or more embodiments described herein.

FIG. 4 illustrates a block diagram representing example components of a key-value memory network model for neural reasoning that can be coupled to training components (FIG. 5) or test/answer components (FIG. 6) in accordance with one or more embodiments described herein.

FIG. 5 illustrates a block diagram representing example training components that can be coupled to key-value memory network model for neural reasoning of FIG. 4 in accordance with one or more embodiments described herein.

FIG. 6 illustrates a block diagram representing example testing/answering components that can be coupled to key-value memory network model for neural reasoning of FIG. 4 in accordance with one or more embodiments described herein.

FIG. 7 illustrates a flow diagram of example operations of a reasoning system in accordance with one or more embodiments described herein.

FIG. 8 illustrates a block diagram of an example, non-limiting system that facilitates a reasoning system in accordance with one or more embodiments described herein.

FIG. 9 illustrates a flow diagram of an example, non-limiting computer-implemented method in accordance with one or more embodiments described herein.

FIG. 10 illustrates a flow diagram of an example, non-limiting computer-program product facilitating a reasoning system in accordance with one or more embodiments described herein.

FIG. 11 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

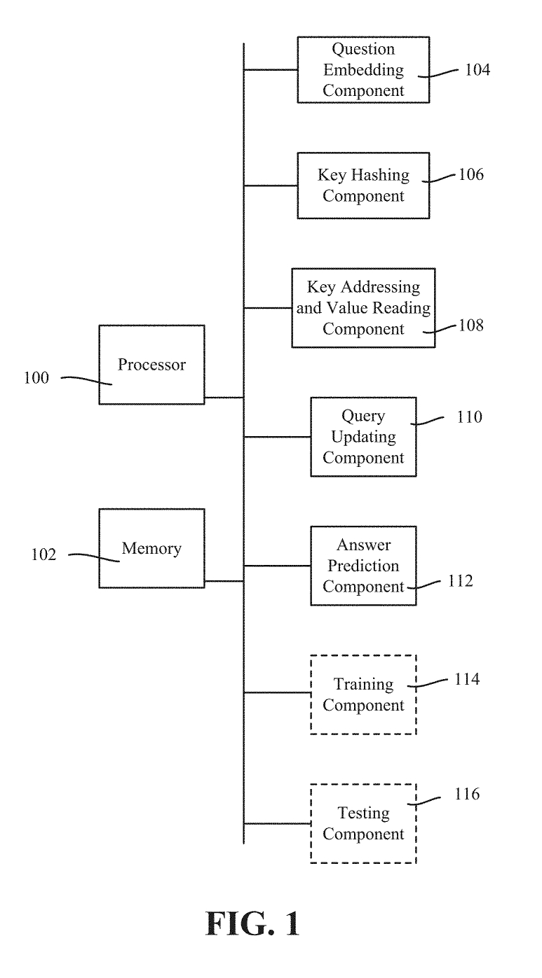

FIG. 1 shows example components of an interpretable general reasoning system 100 including a processor 102 and memory 104 along with components that comprise a key-value memory network architecture. As will be understood, when a user asks a question, via natural language processing the question is first fed to a query embedding component 104 and a hashing component 106. The query embedding component 104 converts the incoming question to an internal feature representation or the like. The hashing component 106 uses the question to import a small number of one or more facts (e.g., only one single fact in one or more implementations) from a knowledge base (KB, or freebase fb) into the memory 102 (part of which is arranged as a key-value memory) for the distinct pairs of entity and relation in the query, rather than all possible facts.

A key addressing and value reading component 108 computes a similarity metric between the query and the embedded keys in the memory and returns associated values for the keys. In a first iteration, referred to as a “hop” herein, a query representation, value representation and key representation are obtained.

A query updating component 110 updates the query representation by incorporating the value representation and key representation obtained in the previous hop, and is able to more precisely address a relevant key at each hop. The key hashing operations, key addressing and value reading operations and query updating operations are repeated in one or more additional hops until a STOP key, which indicates the model is to stop predicting/performing any further hops, is detected.

When the STOP key is detected, an answer prediction component 112 produces structured queries against the knowledge base and returns an answer to the question.

FIG. 1 also shows a training component 114 that can be used to train the reasoning system model as described herein, and a testing component 116, e.g., that can evaluate the reasoning system model by using answers from the answer prediction component 110 against known correct answers.

As will be understood, the key-value memory network system 100 can produce structured queries against knowledge base(s). In this way, the system need not import all relative facts to learn the answer representation, and thus avoids the need for a relatively huge memory size. Instead, the system 100 can import as a little as one single fact into the memory for each distinct pair of entity and relation identified in the question.

Further, the use of the STOP key in the memory stops constructing the structured queries once the system predicts the STOP key in the inference. The query representation update method in the network to learns the STOP strategy using only weak supervision signals. More particularly, the addressed keys and values in previous hops are considered in order to learn a combination matrix to properly combine the addressed keys and values.

As will be understood, the technology described herein is able to decompose a complex question into a sequence of queries, and update the query representation to support multi-hop reasoning. The technology thus enables key-value memory neural network models to perform interpretable reasoning for complex questions. To achieve this, the query updating strategy decouples previously-addressed memory information from the query representation, and uses a STOP strategy to terminate the reasoning process at a proper time to avoid invalid or repeated memory reading without strong annotation signals, which also enables key-value memory neural network models to work in a semantic parsing fashion. Indeed, the technology provides a flexible key-value memory neural network design that can work in both the information retrieval and semantic parsing style with large scale memory. Experimental results on benchmark datasets show that the technology described herein, trained with question-answer pairs only, can provide key-value memory neural network models with better reasoning abilities on complex questions, and achieve state-of-art performances.

As will be understood for the interpretable key-value memory network described herein, for a given question x, a knowledge base KB and the question's answer y, training aims to learn a model such that F(x, KB)=ŷ→y. The function F in general can be composed of various parts, including, key hashing, key addressing, value reading, query updating and answer prediction as generally described with reference to FIG. 1

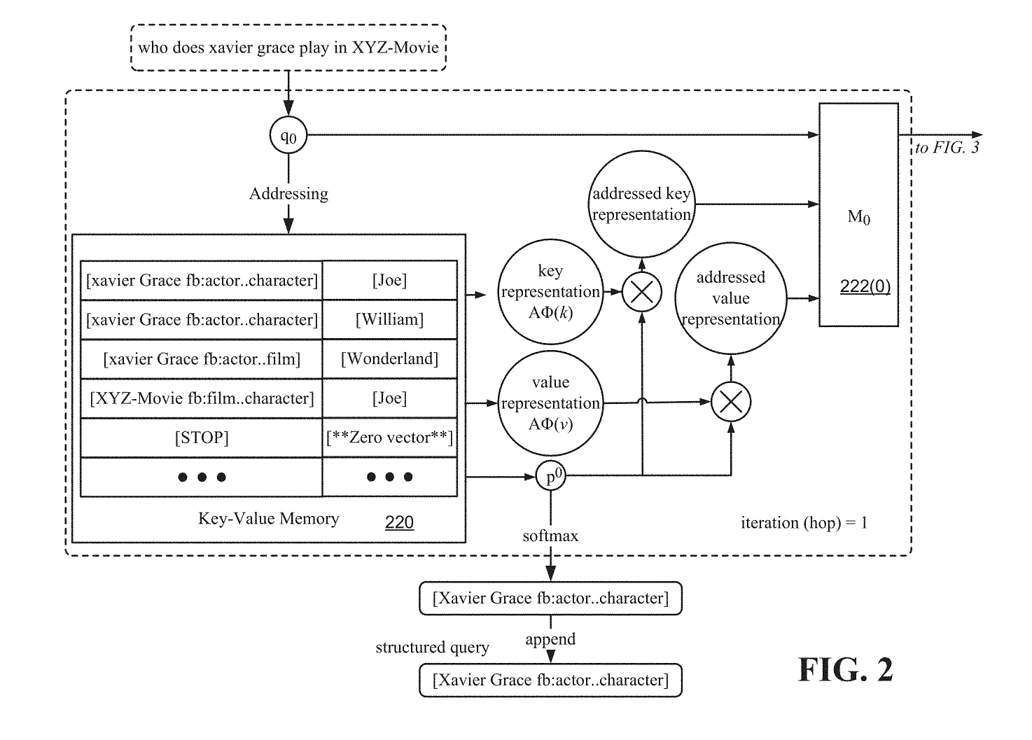

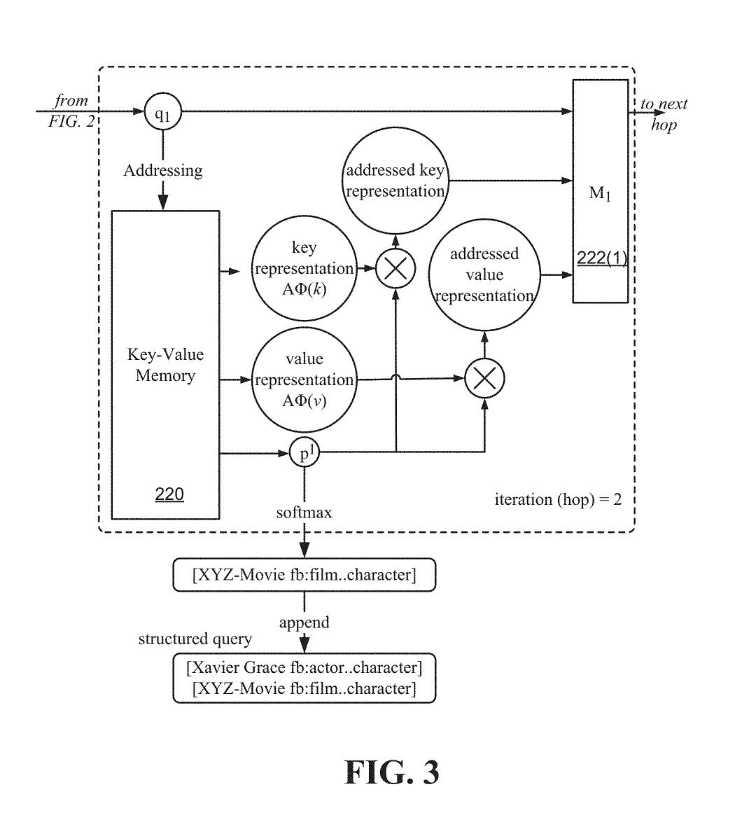

An architecture of one model based on the technology described herein is shown in FIGS. 2 and 3. With respect to key hashing, the knowledge facts in the knowledge base (e.g., freebase fb) are usually organized in a triple <subject, relation, object>, such as <Xavier Grace, fb:actor character, Joe> (e.g., for some hypothetical actor named Xavier Grace and a character he played in a movie). Note that it is straightforward to adapt the model to other organization schemes.

As shown in FIG. 2, these facts are stored in a key-value structured memory 220, where the key k is composed of the left-hand side entity (subject) and the relation, e.g., Xavier Grace fb:actor character, and the value v is the right-hand side entity (object), e.g., Joe. More particularly, the hey hashing component 106 (FIG. 1) can first detect entity mentions in the question, and include the knowledge base facts with one of those entities as a subject in the memory. In order to help the model to avoid repeated or invalid memory reading, a STOP key is inserted into the memory for questions. In one or more implementations, the corresponding value of the STOP key can be a distinct symbol represented by an all-zero vector. The STOP key is designed to tell the model that the model has already accumulated sufficient facts to answer the question, whereby there is no need to find other knowledge facts from the memory in later hops.

In general, key addressing and value reading is a matching process, aiming to find the most suitable key for a given query. It can be formulated as a function that computes the relevance probability pi between the question x and each key kᵢ:

pᵢ=Softmax(AΦ(x)·AΦ(kᵢ))

where Φ is a feature map of dimension D, and A is a d×D matrix. The values of memories are then read by taking weighted sum using the relevance probabilities, and the value representation o is returned

$$o = {\sum }_{i} {p}_{i} A Φ ( {υ}_{i} ) .$$

In one or more implementations, the well-known Bag-of-Words model is used to produce the representations, where the embedding of each word in the question or memory slot is summed together to obtain the vectors.

With respect to query updating, after reading the addressed memory, the initial query representation q=AΦ(x) is updated so that the new evidence o collected in the current hop can be properly considered to retrieve more pertinent information in later hops. Simply adding q and o, then performing a linear transformation does not work well with in the more complicated open domain KB-question and answer tasks that are usually involved with multiple relations or constraints. Therefore, the query updating component 110 (FIG. 1) takes into account the query and addressed memories at the t-th hop when updating the query q^{t+1} for the next hop (FIG. 3):

$${q}^{t + 1} = {M}_{t} \cdot ( {q}^{t} ⊕ \underbrace{{\sum }_{i} {p}_{i}^{t} A Φ ( {k}_{i} )}_{key} ⊕ \underbrace{{\sum }_{i} {p}_{i}^{t} A Φ ( {υ}_{i} )}_{value} )$$

where ⊕ denotes the concatenation of vectors. The query updating is parameterized with a different matrix Mt on the t-th hop, (block 222(0) in FIG. 2, block 222(1) in FIG. 3) which is designed during learning to learn a proper way to combine these three representations.

By way of example, consider the question “who does xavier grace play in XYZ-Movie” (for a hypothetical movie named “XYZ-Movie), the expected answer should follow two constraints: (1) Xavier Grace plays this answer; and (2) this answer is from the movie named XYZ-Movie. To answer this question, the model needs to perform two hops of inference consecutively, that is, matching two keys, namely Xavier Grace fb:actor . . . character and XYZ-Movie fb:film . . . character in the memory. Detaching the information of previously-addressed keys from the query could benefit the latter inference, because the model will be able to focus on the next hop, e.g., the movie XYZ-Movie.

With respect to answer prediction, one solution is to use the o at the final hop of inference to retrieve the answers, by simply computing the similarity between o and all candidate answers. However, many questions in the open domain KB-QA may have multiple answers, and selecting the candidate with the highest similarity results in only one answer. Further, the value representation at the final step may not fully capture the answer information throughout the whole inference process; for example, for multi-constraint questions, the model may address different constraints at different hops.

Therefore, and alternative solution is to globally consider the value representations in the hops to produce a final answer representation. This can be accomplished by accumulating the value representations of the hops to make the resulting representation satisfying the constraints. The answer representation m can be computed at a hop by adding the value representations of both the current and previous hop, i.e., m^{t}=o^{t}+o^{t-1})(t>0), m⁰=o⁰. With the final m obtained traditional IR-based methods can be followed to use the final answer representation (AR) to find the best match over all possible candidate values in the memory, namely the AR approach.

As an alternative, described herein is collecting the best matched keys at the various hops to construct a structured query and execute the structured query over the knowledge base to obtain the (possibly multiple) qualified answers, namely the structured query (SQ) approach. More particularly, the structured query can be constructed by selecting the keys that have the highest relevance probabilities in the various hops, resulting in a sequence of keys starting from sk₀. Starting from sk₀, the key skᵢ is appended into the final structured query until the STOP key is seen at the k-th hop, i.e., SQ={sk₀, . . . , skₖ₋₁}. The SQ approach can output the qualified answers by querying over the knowledge base, whereas the AR approach has difficulties in selecting multiple answers from a ranked list over the memory. However, there are generally no gold-standard structured queries for training, and as a result, different strategies can be adopted to find answers in the training and test phase.

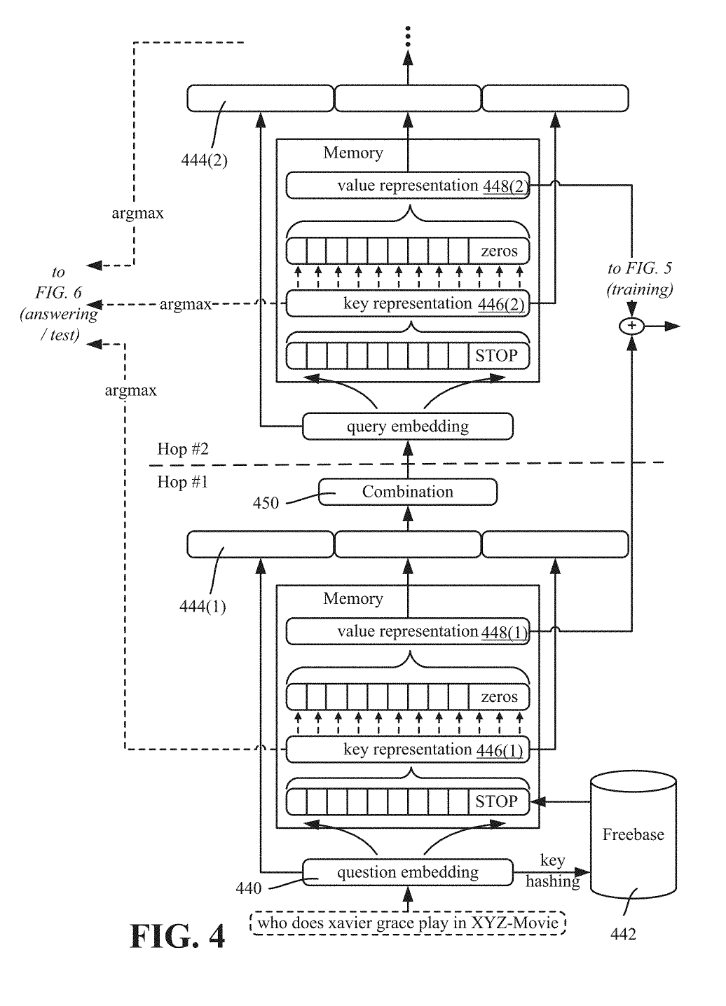

FIGS. 4-6 show additional details of the key-value memory neural network for neural reasoning as described herein. Given a question, e.g., “who does xavier grace play in XYZ-Movie?” initial operations in a first hop #1 comprise question embedding and key hashing (block 440). In general, this comprises matching n-grams of words of the question to entities in the freebase 442, and importing knowledge base facts (e.g., one for any distinct pair of entity and relation in the query, rather than all possible facts). Consider, for example, that the freebase 442 contains at least the following facts: <Movie-XYZ, film . . . character, Joe>, <Xavier Grace fb:actor_character, Joe>, <Xavier Grace fb:actor_character, William>, <Xavier Grace fb:actor_film, Wonderland>, wherein the form of a KB fact is <subject, relation, object>. In one or more implementations, the key is the subject and relation, and the value is the object. The STOP key is also inserted into the memory as a key, where the vector representation of “NONE” is all-zero vector, for example.

As described herein, the key addressing and value reading component 108 (FIG. 1) generates a representation of the question 444(1), the keys 446(1) and the values 448(1) in the memory, e.g., using the bag of words model. As also described herein, key addressing computes the relevance probability by comparing the question and the key representations, and value reading reads the values in the memory slots by taking their weighted sum using the relevance probabilities.

The query updating component 110 (FIG. 1) updates the query representation by combining (block 450) the value representation 446(1) and key representation 448(1) in the previous hop with the query representation 444(1). These three representations are concatenated, with a matrix M used to combine them as described herein.

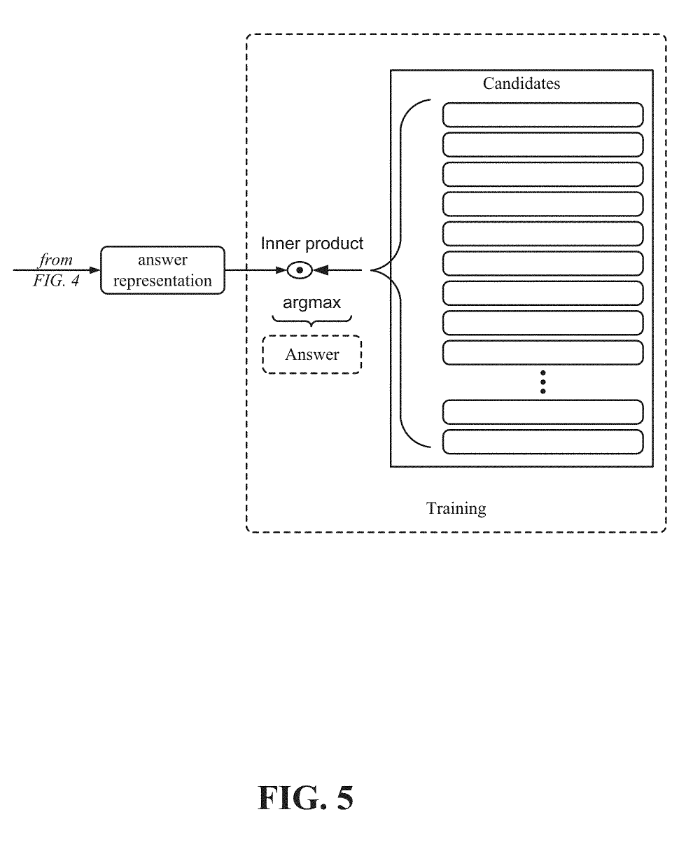

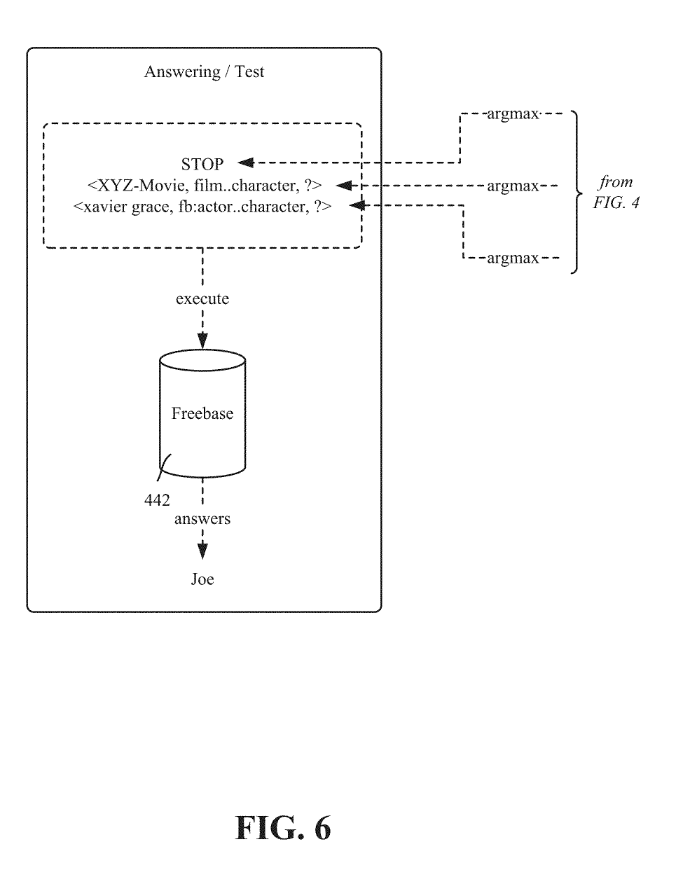

Predicting the answer is part of training (FIG. 5) and testing/answering (FIG. 6). In general, in one or more implementations testing treats the knowledge based entities in the memory as the answer candidates. Classification is performed over these candidates for the value representation, with the cross entropy error taken as the loss function to train the model.

For example, during training, after a fixed number H hops, the AR approach can be followed to use the final m^{H} to compute a prediction over possible candidates, and train the model by minimizing the cross-entropy between the prediction and “gold” results.

More particularly, given an input question x, the network with parameters θ uses the answer representation mₓ^{h} to perform the prediction over candidate answers at hop h, resulting a prediction vector aₓ^{h} where the i-th component is respect to the probability of candidate answer i. Denote tₓ as the target distribution vector. Compute the standard cross-entropy loss between aₓ^{h} and tₓ, and further define the objective function over all training data:

$$L ( θ ) = {\sum }_{x} {\sum }_{h = 1}^{H} {t}_{x} log {a}_{x}^{h} + λ {‖ θ ‖}^{2}$$

where λ is a vector of regularization parameters.

Note that during testing, the SQ approach is followed to collect the final answers by constructing and executing the structured queries over the knowledge base. As exemplified herein, for the example question the model selects three keys, [<xavier grace, fb:actor . . . character>, <XYZ-Movie, film . . . character>, <STOP>]. The first two triples are combined to construct the structured query which is then executed over the knowledge base. Note that the model can still use the AR approach to predict the answers just like in the training phase. Indeed, the model handles the KB-QA task in both the information retrieval and semantic parsing fashion.

Testing and answering (FIG. 6) constructs the structured query by combining the most relevant keys in previous hops with respect to the query representation (sk0, sk1, sk2, . . . , skH). This construction procedure is terminated at the first STOP key, e.g., Q={sk0, . . . , skk−1} based on [<Xavier_grace, actor . . . character>, <XYZ-Movie, film . . . character>, <STOP>]. The structured query is executed over the knowledge base (freebase 442) to retrieve the answers.

Human interaction can be used, based on a natural language generation approach to describe the structured query in a natural language utterance that is provided to the user. Note that one implementation uses a template-based approach to describe the generated structured query. The user gives feedback on the generated structured query, and if the generated structured query is correct, the answer is returned to the user.

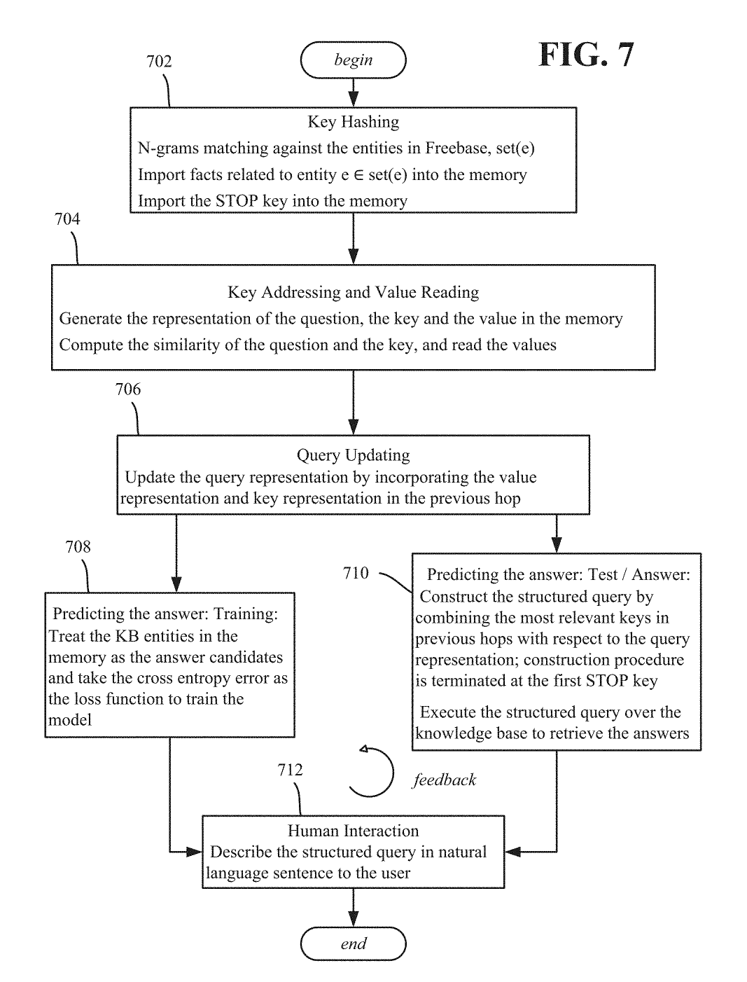

FIG. 7 is a flow diagram that summarizes some of the example operations described herein. Operation 702 represents key hashing, which performs N-grams matching against the entities in freebase, set(e), and imports facts related to entity e∈set(e) into the memory. Operation 702 further imports the STOP key into the memory

Operation 704 represents key addressing and value reading, which generates the representation of the question, the key and the value in the memory.

Key addressing and value reading also computes the similarity of the question and the key, and accordingly reads the values.

Operation 704 represents query updating, which as described herein updates the query representation by incorporating the value representation and key representation in the previous hop.

Operation 706 represents predicting the answer, which for training (operation 708) treats the knowledge base entities in the memory as the answer candidates and takes the cross entropy error as the loss function to train the model.

Predicting the answer with respect to testing or answering a query comprises operation 710 which construct the structured query by combining the most relevant keys in previous hops with respect to the query representation. This construction procedure is terminated at the first STOP key. Operation 710 further executes the structured query over the knowledge base to retrieve the answers.

Operation 712 represents human interaction and in general comprises describing the structured query in natural language sentence to the user. The user may provide feedback; e.g., if the feedback as to the structured query is affirmative the answer is returned to the user; if not, another structured query can be formulated, such as using different templates or rules for additional attempts.

Experiments on benchmark datasets show that the technology described herein outperforms most existing methods by a large margin, even though manually crafted rules are not used. The use of the STOP key further enhances performance, while saving processing and memory resources via reduced iterations.

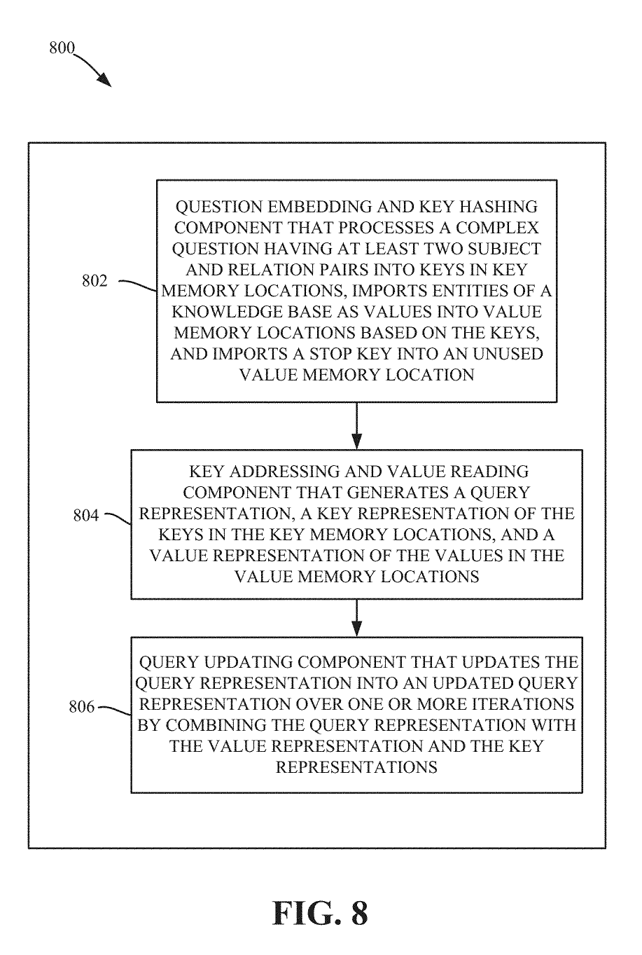

FIG. 8 is a representation of an example system 800, which can comprise a memory that stores computer executable components and a processor that executes computer executable components stored in the memory. The computer executable components can comprise a question embedding and key hashing component (block 802) that processes a complex question having at least two subject and relation pairs into keys in key memory locations, imports entities of a knowledge base as values into value memory locations based on the keys, and imports a stop key into an unused value memory location. Other components can comprise a key addressing and value reading component (block 804) that generates a query representation, a key representation of the keys in the key memory locations, and a value representation of the values in the value memory locations, and a query updating component (block 806) that updates the query representation into an updated query representation over one or more iterations by combining the query representation with the value representation and the key representations.

The query updating component can compute relevance probability values between the query representation and the keys, and read values of the value memory locations by taking a weighted sum in which the weights are based on the relevance probabilities of the corresponding keys. The query updating component can detect the stop key, and in response to detection of the stop key, stop further updates to the query representation.

An answer prediction component can construct a structured query based on the relevance probability values and execute the structured query over the knowledge base to obtain an answer to the complex question. A natural language generation component can describe the structured query in a natural language output presentation to a user, and an input component can obtain data from the user with respect to the natural language output presentation; if the input data indicates the structured query is accurate based on the natural language output presentation, the input component can instruct the answer output component to return the answer to the complex question.

The question embedding and key hashing component can performs N-gram matching against the entities in the knowledge base to import the entities of the knowledge base as values into the value memory locations.

The key addressing and value reading component can use a bag of words model to generate the question representation, the key representation of the keys in the key memory locations, and the value representation of the values in the value memory locations.

The query updating component can concatenate the query representation with the value representation and the key representation into a concatenated vector.

A training component can train a model by using entities of the knowledge base in the memory as answer candidates, classify the answer candidates with respect to a ground truth value, and use cross entropy error as a loss function.

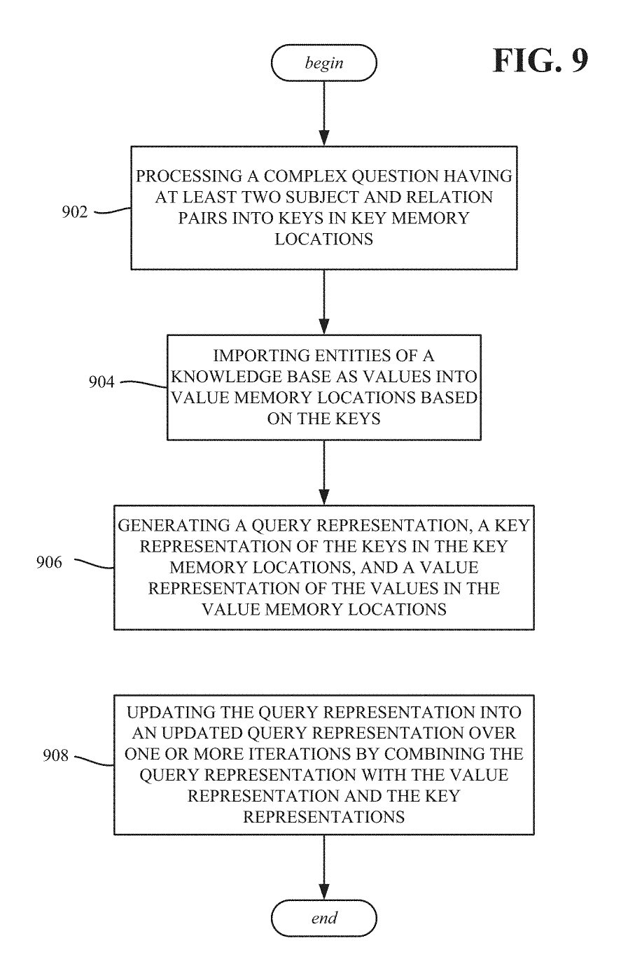

FIG. 9 exemplifies example operations of a computer-implemented method, comprising, processing operation (902) a complex question having at least two subject and relation pairs into keys in key memory locations, and importing entities of a knowledge base as values into value memory locations based on the keys (operation 904). Operation 906 represents generating a query representation, a key representation of the keys in the key memory locations, and a value representation of the values in the value memory locations. Operation 908 represents updating the query representation into an updated query representation over one or more iterations by combining the query representation with the value representation and the key representations.

Aspects can include importing a stop key into an unused key memory location, and stopping additional iterations upon detecting the stop key.

Aspects can include computing relevance probability values between the query representation and the keys, and reading values of the value memory locations comprising taking a weighted sum in which the weights are based on the relevance probabilities of the corresponding keys.

Aspects can include maintaining a most relevant key per iteration based on the relevance probability values computed in an iteration with respect to the query representation of that iteration, and constructing a structured query by combining the most relevant keys in the iterations into a combined set of keys that represent the structured query.

Aspects can include executing the structured query over the knowledge base to retrieve an answer to the complex question. Aspects can include describing the structured query in a natural language output presentation to a user.

Updating the query representation into an updated query representation can comprises concatenating the query representation with the value representation and the key representation into a concatenated vector, and obtaining the updated query representation by calculating a dot product of the concatenated vector and a learned matrix.

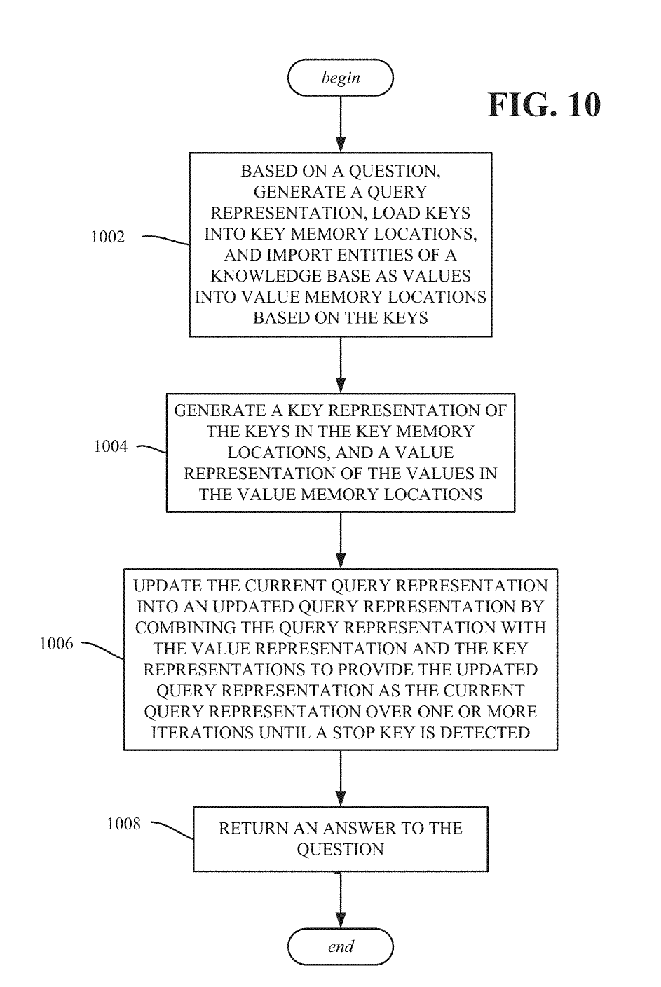

FIG. 10 exemplifies a computer program product facilitating providing efficient convolution neural networks, in which the computer program product comprises a computer readable storage medium having program instructions embodied therewith. The program instructions can be executable by a processor to cause the processor to (block 1002) based on a question, generate a query representation, load keys into key memory locations, and import entities of a knowledge base as values into value memory locations based on the keys, and (block 1004) generate a key representation of the keys in the key memory locations, and a value representation of the values in the value memory locations. Block 1006 represents operations to update the current query representation into an updated query representation by combining the query representation with the value representation and the key representations to provide the updated query representation as the current query representation over one or more iterations until a stop key is detected, and block 1008 represents operations to return an answer to the question.

The program instructions can be further executable by the processor to cause the processor to maintain a most relevant key per iteration based on the relevance probability values computed in that iteration, and construct a structured query by combining the most relevant keys into a combined set of keys that represent the structured query. The program instructions can be further executable by the processor to cause the processor to execute the structured query over the knowledge base to retrieve the answer to the complex question. The program instructions can be further executable by the processor to describe the structured query in a natural language output presentation to a user, receive input data from the user with respect to the natural language output presentation, evaluate the input data, and if the input data indicates the structured query is accurate based on the natural language output presentation, output the answer to the question to the user.

As can be seen, the technology described herein can provide key-value memory neural networks for knowledge based question answering (KB-QA). A query updating strategy decouples previously-addressed memory information from the query representation, a STOP key terminates the reasoning process at a proper time to avoid invalid or repeated memory reads.

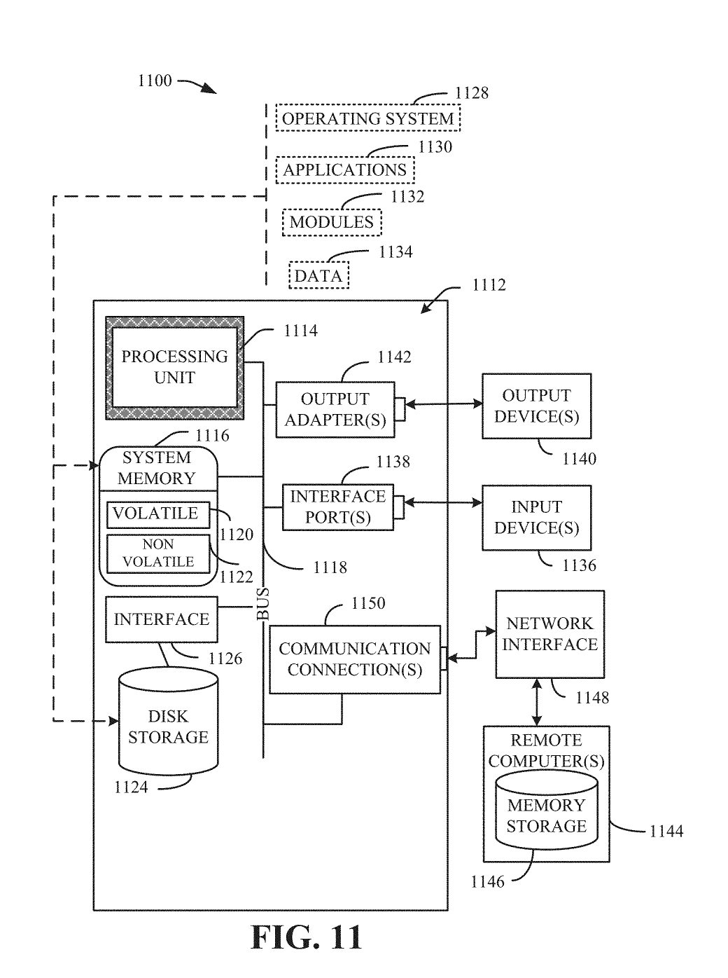

In order to provide a context for the various aspects of the disclosed subject matter, FIG. 11 as well as the following discussion are intended to provide a general description of a suitable environment in which the various aspects of the disclosed subject matter can be implemented. FIG. 11 illustrates a block diagram of an example, non-limiting operating environment in which one or more embodiments described herein can be facilitated. Repetitive description of like elements employed in other embodiments described herein is omitted for sake of brevity.

With reference to FIG. 11, a suitable operating environment 1100 for implementing various aspects of this disclosure can also include a computer 1112. The computer 1112 can also include a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114. The system bus 1118 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1116 can also include volatile memory 1120 and nonvolatile memory 1122. The basic input/output system (BIOS), containing the basic routines to transfer information between elements within the computer 1112, such as during start-up, is stored in nonvolatile memory 1122. Computer 1112 can also include removable/non-removable, volatile/non-volatile computer storage media. FIG. 11 illustrates, for example, a disk storage 1124. Disk storage 1124 can also include, but is not limited to, devices like a magnetic disk drive, floppy disk drive, tape drive, Jaz drive, Zip drive, LS-100 drive, flash memory card, or memory stick. The disk storage 1124 also can include storage media separately or in combination with other storage media. To facilitate connection of the disk storage 1124 to the system bus 1118, a removable or non-removable interface is typically used, such as interface 1126. FIG. 11 also depicts software that acts as an intermediary between users and the basic computer resources described in the suitable operating environment 1100. Such software can also include, for example, an operating system 1128. Operating system 1128, which can be stored on disk storage 1124, acts to control and allocate resources of the computer 1112.

System applications 1130 take advantage of the management of resources by operating system 1128 through program modules 1132 and program data 1134, e.g., stored either in system memory 1116 or on disk storage 1124. It is to be appreciated that this disclosure can be implemented with various operating systems or combinations of operating systems. A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port can be used to provide input to computer 1112, and to output information from computer 1112 to an output device 1140. Output adapter 1142 is provided to illustrate that there are some output devices 1140 like monitors, speakers, and printers, among other output devices 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a computer, a server, a router, a network PC, a workstation, a microprocessor based appliance, a peer device or other common network node and the like, and typically can also include many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1150 refers to the hardware/software employed to connect the network interface 1148 to the system bus 1118. While communication connection 1150 is shown for illustrative clarity inside computer 1112, it can also be external to computer 1112. The hardware/software for connection to the network interface 1148 can also include, for exemplary purposes only, internal and external technologies such as, modems including regular telephone grade modems, cable modems and DSL modems, ISDN adapters, and Ethernet cards.

The present invention can be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a memory that stores computer executable components;
a processor that executes computer executable components stored in the memory, wherein the computer executable components comprise:
a question embedding and key hashing component that processes a complex question having at least two subject and relation pairs into keys in key memory locations, imports entities of a knowledge base as values into value memory locations based on the keys, and imports a stop key into an unused value memory location;
a key addressing and value reading component that generates a query representation, a key representation of the keys in the key memory locations, and a value representation of the values in the value memory locations; and
a query updating component that updates the query representation into an updated query representation over one or more iterations by combining the query representation with the value representation and the key representations.

2. The system of claim 1, wherein the query updating component computes relevance probability values between the query representation and the keys, and reads values of the value memory locations comprising taking a weighted sum in which the weights are based on the relevance probabilities of the corresponding keys.

3. The system of claim 1, wherein the query updating component detects the stop key, and in response to detection of the stop key, stops further updates to the query representation.

4. The system of claim 1, further comprising an answer prediction component that constructs a structured query based on the relevance probability values and executes the structured query over the knowledge base to obtain an answer to the complex question.

5. The system of claim 4, further comprising a natural language generation component that describes the structured query in a natural language output presentation to a user, and an input component that obtains data from the user with respect to the natural language output presentation, and if the input data indicates the structured query is accurate based on the natural language output presentation, the input component coupled to instruct the answer output component to return the answer to the complex question.

6. The system of claim 1, wherein the question embedding and key hashing component performs N-gram matching against the entities in the knowledge base to import the entities of the knowledge base as values into the value memory locations.

7. The system of claim 1, wherein the key addressing and value reading component uses a bag of words model to generate the question representation, the key representation of the keys in the key memory locations, and the value representation of the values in the value memory locations.

8. The system of claim 1, wherein the query updating component concatenates the query representation with the value representation and the key representation into a concatenated vector.

9. The system of claim 1, further comprising a training component that trains a model by using entities of the knowledge base in the memory as answer candidates, classifying the answer candidates with respect to a ground truth value, and using cross entropy error as a loss function.

10. A computer-implemented method comprising:
processing a complex question having at least two subject and relation pairs into keys in key memory locations,
importing entities of a knowledge base as values into value memory locations based on the keys;
generating a query representation, a key representation of the keys in the key memory locations, and a value representation of the values in the value memory locations; and
updating the query representation into an updated query representation over one or more iterations by combining the query representation with the value representation and the key representations.

11. The computer-implemented method of claim 10, further comprising importing a stop key into an unused key memory location, and stopping additional iterations upon detecting the stop key.

12. The computer-implemented method of claim 10, further comprising computing relevance probability values between the query representation and the keys, and reading values of the value memory locations comprising taking a weighted sum in which the weights are based on the relevance probabilities of the corresponding keys.

13. The computer-implemented method of claim 12, further comprising maintaining a most relevant key per iteration based on the relevance probability values computed in an iteration with respect to the query representation of that iteration, and constructing a structured query by combining the most relevant keys in the iterations into a combined set of keys that represent the structured query.

14. The computer-implemented method of claim 13, further comprising executing the structured query over the knowledge base to retrieve an answer to the complex question.

15. The computer-implemented method of claim 13, further comprising describing the structured query in a natural language output presentation to a user.

16. The computer-implemented method of claim 10, wherein the updating the query representation into an updated query representation comprises concatenating the query representation with the value representation and the key representation into a concatenated vector, and obtaining the updated query representation by calculating a dot product of the concatenated vector and a learned matrix.

17. A computer program product facilitating reasoning using a key value memory network and comprising a computer readable storage medium having program instructions embodied therewith, the program instructions executable by a processor to cause the processor to:
based on a question, generate a query representation, load keys into key memory locations, and import entities of a knowledge base as values into value memory locations based on the keys;
generate a key representation of the keys in the key memory locations, and a value representation of the values in the value memory locations;
update the current query representation into an updated query representation by combining the query representation with the value representation and the key representations to provide the updated query representation as the current query representation over one or more iterations until a stop key is detected; and
return an answer to the question.

18. The computer program product of claim 17, wherein the program instructions are further executable by the processor to cause the processor to maintain a most relevant key per iteration based on the relevance probability values computed in that iteration, and construct a structured query by combining the most relevant keys into a combined set of keys that represent the structured query.

19. The computer program product of claim 17, wherein the program instructions are further executable by the processor to cause the processor to execute the structured query over the knowledge base to retrieve the answer to the complex question.

20. The computer program product of claim 17, wherein the program instructions are further executable by the processor to describe the structured query in a natural language output presentation to a user, receive input data from the user with respect to the natural language output presentation, evaluate the input data, and if the input data indicates the structured query is accurate based on the natural language output presentation, output the answer to the question to the user.
